(19) United States
(12) Patent Application Publication
(10) Pub. No.: US 2003/0130751 A1
(43) Pub. Date: Jul. 10, 2003

(54) New filter bank for graphics equalizer implementation

(75) Inventor: Y. C. Lim, Singapore (SG)

Correspondence Address: GEORGE O. SAILE & ASSOCIATES, 28 DAVIS AVENUE, POUGHKEEPSIE, NY, 12603, US

(73) Assignee: FreeSystems Pte.,Ltd.

(21) Appl. No.: 10/041,044

(22) Filed: Jan. 9, 2002

(51) Int. Cl. G05B 13/02; G06F 17/10

(52) U.S. Cl. 700/55

(57) ABSTRACT

It is the objective of this invention to provide a multichannel digital filter bank circuit and a method implemented by cascading sub-filters of the recursive type suitable for graphically equalizing electrical signals received via a communication path. It is also an objective of this invention to produced equalized signals having minimal distortion of signal spectral characteristics including magnitude and phase. The circuit of this invention is implemented with cascaded connections of first order or second order digital filters. It is an additional objective of this invention to provide for the programming of the individual transfer functions of the above digital filters so as to produce unity gain. This unity gain case results in an output signal which is an exact replica of the input signal with no delay. This result indicates the minimal distortion introduced by the method of this invention.

### BACKGROUND OF THE INVENTION

1. Field of the Invention

This invention relates to circuits and a method for implementing graphics equalizers utilizing a filter bank arrangement for use in audio and electrical systems. More particularly this invention relates to circuits and a method utilizing cascaded recursive digital filters whose arrangement has the advantage of not distorting the spectral characteristics of magnitude and phase and does not delay the signal.

2. Description of Related Art

Today, conventional filter banks are implemented using parallel arrangements. In FIG. 1, the input signal 150 is fed into a parallel bank of bandpass filters F1, F2, F3, . . . Fm (110, 120, 130, 140). Each bandpass filter filters and selects one channel of the signal for gain adjustment by a gain control circuit G1, G2, G3, . . . Gm (170, 180, 190, 195) in series with each parallel filter element. The frequency responses of the various channels of the filter bank are shown in FIG. 2. In FIG. 2, F1, F2, F3, . . . Fm (210, 220, 230, 240) are the center frequencies of the bandpass filters of FIG. 1. In FIG. 1, the outputs of all of the gain controls are summed 198 to produce the final output 160. A common problem with graphics equalizers built using the structure of FIG. 1 is that when all of the channel gain controls, Gm, are set to unity in order to create a flat response, the output of the filter bank is not an exact replica of the input. The output contains phase and amplitude distortion. FIG. 3 shows a typical frequency response plot 310 for the above conventional graphics equalizer when all of the channel gain settings, Gm are set to unity in a low cost filter bank implementation. In addition, in the conventional parallel filter bank implementation of FIG. 1, the output is a delayed replica of the input when all of the channel gain control variables are set to unity.

U.S. Pat. No. 4,284,965 (Higashi, et al.) “Tone Control Device” describes a tone control device comprised of multiple mixers and at least one band rejection filter. The device allows independent adjustment of the center frequency, Q value, and gain independently.

U.S. Pat. No. 5,524,022 (Kihara, et al.) “Digital Graphic Equalizer” describes a digital graphic equalizer used to obtain a boost characteristic and an attenuation characteristic using band pass filters constituted by a digital filter and an adder.

U.S. Pat. No. 5,418,859 (Cho) “Correcting apparatus of sound signal distortion by way of audio frequency band segmentation” describes a correcting apparatus of sound signal distortion by means of segmenting the audio frequency band more heavily in the low frequency bands than in the high frequency bands.

U.S. Pat. No. 4,891,841 (Bohn) “Reciprocal, Subtractive, and Audio Spectrum Equalizer” describes an equalizer circuit having adjustable band pass filters connected with operational amplifiers in feedforward and feedback paths so as to form frequency selective boost and cut signal components.

U.S. Pat. No. 4,316,060 (Adams, et al.) “Equalizing System” describes a system for modifying an input signal representative of original sound so as to correct for nonflat frequency response distortion caused by the audio equipment and listening environment.

U.S. Pat. No. 5,892,833 (Maag, et al.) “Gain and Equalization System and Method” describes a multi-band digital gain and equalizer system for receiving and processing audio signals.

U.S. Pat. No. 5,194,832 (Iga) “Transversal Equalizer” describes an equalizer having a specified number of rear taps.

U.S. Pat. No. 4,845,758 (Op de Beek, et al.) “Equalizer with Adjustable Band Filters and a Digital Filter Suitable for Use in the Equalizer” describes a manually operated or automatic equalizer with adjustable band filters.

U.S. Pat. No. 5,841,810 (Wong, et al.) “Multiple Stage Adaptive Equalizer” describes an adaptive equalizer which includes multiple, serially coupled adaptive filter stages.

### BRIEF SUMMARY OF THE INVENTION

It is the objective of this invention to provide a multichannel digital filter bank circuit and a method implemented by cascading sub-filters of the recursive type suitable for graphically equalizing electrical signals received via a communication path. It is also an objective of this invention to produce equalized signals having minimal distortion of signal spectral characteristics including magnitude and phase. The circuit of this invention is implemented with cascaded connections of first order or second order digital filters. It is an additional objective of this invention to provide for the programming of the individual transfer functions of the above digital filters so as to produce unity gain. This unity gain case results in an output signal which is an exact replica of the input signal with no delay. This result indicates the minimal distortion introduced by the method of this invention.

### BRIEF DESCRIPTION OF THE DRAWINGS

FIG. 1 shows a prior art conventional filter bank implemented with parallel structure.

FIG. 2 shows the frequency response of the prior art parallel filter bank of FIG. 1.

FIG. 3 shows a typical frequency response plot of the prior art parallel filter bank of FIG. 1 when all the channel gain settings are set to unity.

FIG. 4 shows the cascade implementation of this invention.

FIG. 5 shows a typical frequency response plot of the cascade implementation of this invention.

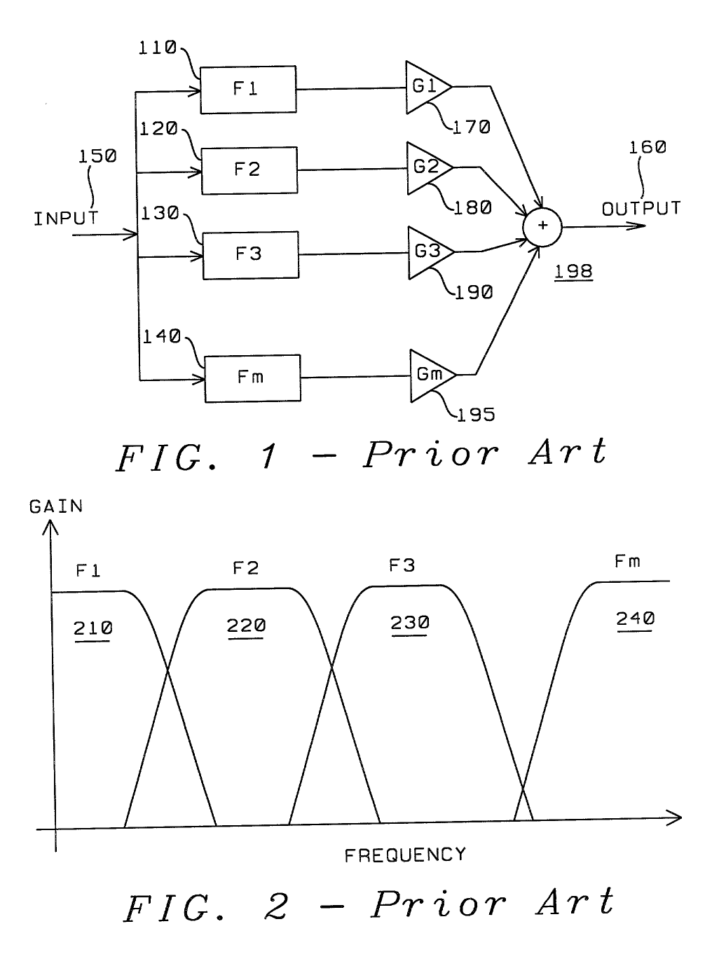

### DETAILED DESCRIPTION OF THE INVENTION

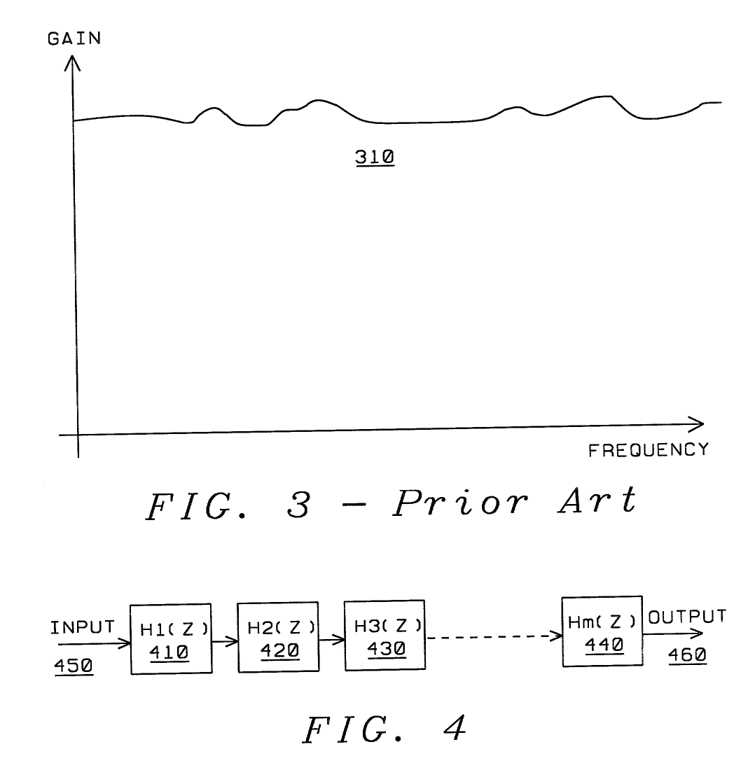

FIG. 4 shows a block diagram of the embodiment of this invention. The audio or electrical signal 450 to be equalized enters the first digital filter 410 of the 5 cascaded filter bank made up of digital filters H1, H2, H3, . . . , Hm (410, 420, 430, 440). H1, H2, H3, . . . , Hm represent the transfer functions of the digital filters in the serial filter bank just described. The resultant equalized signal 460 comes out of the filter represented by Hm 440.

The overall z-transform transfer function, H(z), of the composite filter bank for implementing a graphics equalizer is given by

H(z)=H1(z)H2(z)H3(z) . . . Hm(z)

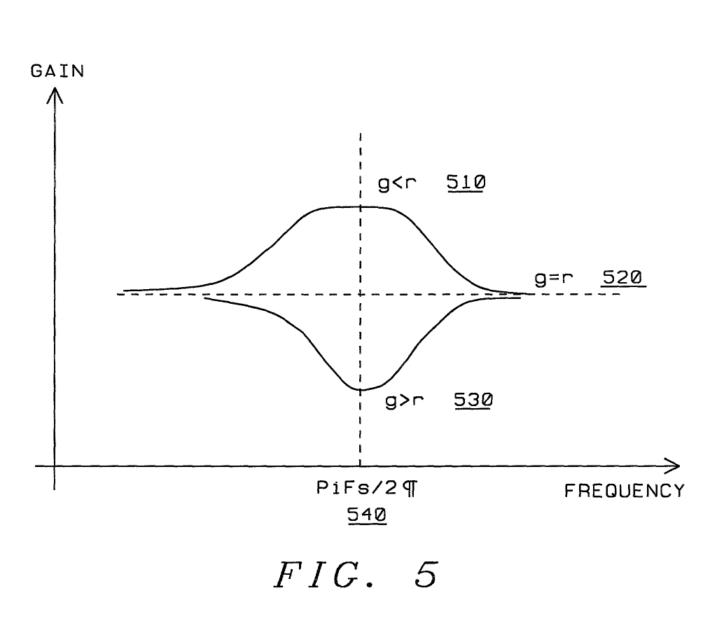

H, (z) controls the gain of the i th channel of the graphics equalizer where i=1, 2, 3, . . . , m. Hi(z) is not a bandpass filter but is either a notch or line enhancer depending on whether the spectral of that particular channel is to be attenuated or enhanced. A typical frequency response plot for Hi(z) is shown in FIG. 5. Hi(z) may be of any order. The plot of FIG. 5 represents the use of second order filters.

However, if Hi(z) is 1st order, then it is given by

Furthermore, a and b must be of the same sign. If a is greater than b, then it is a notch. If a is smaller than b, then it is a line enhancer. If a is equal to b, then:

Hi(z)=1 and passes all signals without affecting the signals' spectral characteristics. Its gain at d.c. (or half sampling frequency depending on the signs of a and b is:

Back to FIG. 5, if Hi(z) is 2^{nd} order, then it is given by:

Both g, and r are positive and less than unity.

The gain 540 of Hi(z) at:

is determined by the values of g, and r, (where Fs, is the sampling frequency) and is given by:

If g is greater than r, then it is a notch 530. If g is smaller than r, then it is a line enhancer 510. If g is equal to r, then Hi(z)=1 and passes all signals without affecting the signals' spectral characteristics 520.

If H1(Z)=H2(Z)=H3(Z)= . . . =Hm(z)=1, then the overall H(z)=1 and the output is an exact replica of the input.

While this invention has been particularly shown and described with Reference to the preferred embodiments thereof, it will be understood by those Skilled in the art that various changes in form and details may be made without Departing from the spirit and scope of this invention.

What is claimed is:

1. A multichannel digital filter bank implemented by cascading sub-filters of the recursive type suitable for graphically equalizing electrical signals received via a communication path having minimal distortion of signal spectral characteristics including magnitude and phase nor does this method introduce additional delay to the signal comprising:
A plurality of first order or second order digital filters, connected in a cascade fashion.

2. The multichannel digital filter bank of claim 1, wherein said digital filters are first order and have a transfer function whos equation is:

3. The multichannel digital filter bank of claim 1 wherein said filters are second order and have a transfer function whose equation is:

4. A method for equalizing electrical signals received via a communication path having minimal distortion of signal spectral characteristics including magnitude and phase wherein this method does not introduce additional delay to the signal, comprising the steps of:
Filtering the electrical signals using first order or second order digital filtering, wherein said filters are cascade connected.

5. The method of claim 4, wherein the digital filters are of the first order, comprising the steps of:
using a transfer function whose equation is:

6. The method of claim 4, wherein the digital filters are of the first order, comprising the steps of:
using a transfer function whose equation is:
parameters g and r of the digital filters which determine whether the filter bank enhances the signal, attenuates the signal or simply returns the indentical input signal undelayed as the output.
